(19) United States
(12) Patent Application Publication
(10) Pub. No.: US 2022/0070110 A1
(43) Pub. Date: Mar. 3, 2022

(54) SYSTEM FOR ADJUSTING RESOURCE ALLOCATION BASED ON USER SELECTION

(71) Applicant: BANK OF AMERICA CORPORATION, Charlotte, NC (US)

(72) Inventors: Victoria L. Dravneek, Charlotte, NC (US); Brandy Lachole Brown, Charlotte, NC (US); Karen Lea MacQueen, Lyndhurst, OH (US); Jill Marie Moser, Louisville, KY (US); Matthew Murphy, Charlotte, NC (US); Matthew Robert Gray Pitner, Alpharetta, GA (US)

(73) Assignee: BANK OF AMERICA CORPORATION, Charlotte, NC (US)

(21) Appl. No.: 17/002,012

(22) Filed: Aug. 25, 2020

(51) Int. Cl. H04L 12/911; G06F 9/50

(52) U.S. Cl. CPC H04L 47/70; G06F 9/5077; G06F 9/5011; G06F 9/5027

(57) ABSTRACT

Systems, computer program products, and methods are described herein for resource allocation based on user selection. The present invention may be configured to provide one or more resource allocation offers to a user device associated with a user and receive, from the user device, an acceptance of a first resource allocation offer of the one or more resource allocation offers. The present invention may be configured to adjust, based on the acceptance of the first resource allocation offer, a second resource allocation offer from an initial amount of resources to an adjusted amount of resources, where the adjusted amount of resources is greater than the initial amount of resources. The present invention may be configured to provide the second resource allocation offer to the user device.

### FIELD OF THE INVENTION

The present invention embraces a system for adjusting resource allocation based on user selection.

### BACKGROUND

An entity may provide one or more resource allocation offers to a user to encourage the user to conduct resource distributions with one or more other entities. For example, the other entities may provide, to the entity, lists of resource allocation offers for the entity to provide to the user in an effort to encourage the user to conduct resource distributions with the other entities.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, a system for adjusting resource allocation based on user selection is presented. The system comprises: at least one non-transitory storage device; and at least one processing device coupled to the at least one non-transitory storage device, wherein the at least one processing device is configured to: provide one or more resource allocation offers to a user device associated with a user; receive, from the user device, an acceptance of a first resource allocation offer of the one or more resource allocation offers; adjust, based on the acceptance of the first resource allocation offer, a second resource allocation offer from an initial amount of resources to an adjusted amount of resources, wherein the adjusted amount of resources is greater than the initial amount of resources; and provide the second resource allocation offer to the user device.

In some embodiments, the at least one processing device is configured to, when providing the one or more resource allocation offers to the user device, cause the user device to display the one or more resource allocation offers via a graphical user interface.

In some embodiments, the at least one processing device is configured to, when providing the one or more resource allocation offers to the user device, provide a notification comprising the one or more resource allocation offers to the user device.

In some embodiments, the at least one processing device is configured to generate, based on historical data associated with resource distributions, the one or more resource allocation offers.

In some embodiments, the historical data associated with resource distributions comprises historical data associated with resource distributions associated with the user.

In some embodiments, the historical data associated with resource distributions comprises historical data associated with resource distributions associated with multiple users.

In some embodiments, the second resource allocation offer is related to the first resource allocation offer.

In some embodiments, the at least one processing device is configured to adjust the second resource allocation offer based on rules.

In some embodiments, the at least one processing device is configured to, when adjusting the second resource allocation offer, communicate with an entity associated with the second resource allocation offer.

In some embodiments, the at least one processing device is configured to, when adjusting the second resource allocation offer, communicate with a plurality of entities associated with a plurality of resource allocation offers, wherein the plurality of resource allocation offers includes the second resource allocation offer.

In some embodiments, the at least one processing device is configured to: when adjusting the second resource allocation offer, communicate with a plurality of entities associated with a plurality of resource allocation offers, wherein the plurality of resource allocation offers includes the second resource allocation offer; when adjusting the second resource allocation offer, receive from the plurality of entities, updated amounts of resources for the plurality of resource allocation offers, wherein the updated amounts of resources are updated based on the acceptance of the first resource allocation offer; and when providing the second resource allocation offer to the user device, provide the plurality of resource allocation offers to the user device.

In some embodiments, the at least one processing device is configured to: when providing the one or more resource allocation offers to the user device, provide a plurality of resource allocation offers to the user device; when adjusting the second resource allocation offer, communicate with a plurality of entities associated with the plurality of resource allocation offers, wherein the plurality of resource allocation offers includes the second resource allocation offer; when adjusting the second resource allocation offer, receive from the plurality of entities, updated amounts of resources for the plurality of resource allocation offers, wherein the updated amounts of resources are updated based on the acceptance of the first resource allocation offer; and when providing the second resource allocation offer to the user device, provide the plurality of resource allocation offers to the user device.

In some embodiments, the at least one processing device is configured to: receive, from the user device, another acceptance of the second resource allocation offer; adjust, based on the other acceptance of the second resource allocation offer, a third resource allocation offer from a first amount of resources to a second amount of resources, wherein the first amount of resources is greater than the second amount resources; and provide the third resource allocation offer to the user device.

In some embodiments, the at least one processing device is configured to cause, based on the acceptance of the first resource allocation offer, an autonomous vehicle to deliver an object to an address.

In some embodiments, the at least one processing device is configured to: receive, from the user device, another acceptance of the second resource allocation offer; and cause, based on the other acceptance of the second resource allocation offer, an autonomous vehicle to deliver an object to an address.

In another aspect, a computer program product for adjusting resource allocation based on user selection is presented. The computer program product comprises a non-transitory computer-readable medium comprising code causing a first apparatus to: provide one or more resource allocation offers to a user device associated with a user; receive, from the user device, an acceptance of a first resource allocation offer of the one or more resource allocation offers; adjust, based on the acceptance of the first resource allocation offer, a second resource allocation offer from an initial amount of resources to an adjusted amount of resources, wherein the adjusted amount of resources is greater than the initial amount of resources; and provide the second resource allocation offer to the user device.

In some embodiments, the non-transitory computer-readable medium comprises code causing the first apparatus to, when providing the one or more resource allocation offers to the user device, cause the user device to display the one or more resource allocation offers via a graphical user interface.

In some embodiments, the non-transitory computer-readable medium comprises code causing the first apparatus to, when providing the one or more resource allocation offers to the user device, provide a notification comprising the one or more resource allocation offers to the user device.

In some embodiments, the non-transitory computer-readable medium comprises code causing the first apparatus to generate, based on historical data associated with resource distributions, the one or more resource allocation offers.

In yet another aspect, a method for adjusting resource allocation based on user selection is presented. The method comprises providing one or more resource allocation offers to a user device associated with a user; receiving, from the user device, an acceptance of a first resource allocation offer of the one or more resource allocation offers; adjusting, based on the acceptance of the first resource allocation offer, a second resource allocation offer from an initial amount of resources to an adjusted amount of resources, wherein the adjusted amount of resources is greater than the initial amount of resources; and providing the second resource allocation offer to the user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for adjusting resource allocation based on user selection, in accordance with an embodiment of the invention;

FIG. 2 illustrates a process flow for adjusting resource allocation based on user selection, in accordance with an embodiment of the invention; and

FIG. 3 illustrates a graphical user interface for adjusting resource allocation based on user selection, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, the data may be related to people who work for the entity, products, services, and/or the like offered and/or provided by the entity, customers of the entity, other aspect of the operations of the entity, and/or the like. As such, the entity may be an institution, group, association, financial institution, establishment, company, union, authority, merchant, service provider, and/or or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein.

As used herein, a “user interface” may be any device or software that allows a user to input information, such as commands and/or data, into a device, and/or that allows the device to output information to the user. For example, a user interface may include a graphical user interface (GUI) and/or an interface to input computer-executable instructions that direct a processing device to carry out functions. The user interface may employ input and/or output devices to input data received from a user and/or output data to a user. Input devices and/or output devices may include a display, mouse, keyboard, button, touchpad, touch screen, microphone, speaker, LED, light, joystick, switch, buzzer, bell, and/or other devices for communicating with one or more users.

As used herein, an “engine” may refer to core elements of a computer program, part of a computer program that serves as a foundation for a larger piece of software and drives the functionality of the software, and/or the like. An engine may be self-contained, but may include externally-controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “resource” may generally refer to objects, products, devices, goods, commodities, services, offers, discounts, currency, cash, a cash equivalent, a reward, a reward point, a benefit reward, a bonus mile, cash back, a credit, and/or the like, and/or the ability and opportunity to access and use the same. As used herein, a “resource allocation offer” may generally refer to an offer to provide a resource (e.g., to an entity, a user, a device, a system, and/or the like). A resource allocation offer may include attributes and/or terms, such as an amount of resources to be provided, a time and/or period of time for providing the resources, a condition upon which the resources will be provided, and/or the like. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source” may generally refer to an account, a system, and/or the like associated with a user and/or a type of resources (e.g., standard resources, auxiliary resources, supplementary resources, and/or the like). As used herein, a “standard source” may generally refer to a source associated with standard resources, such as a checking account, a deposit account, a savings account, a credit account, and/or the like. As used herein, an “auxiliary source” and/or a “supplementary source” may generally refer to a source associated with auxiliary resources and/or supplementary resources, such as a rewards account, a rewards points account, a benefit rewards account, a bonus miles account, a cash back account, and/or the like. Some example implementations include one or more sources associated with a user, where the one or more sources include one or more standard sources, one or more auxiliary sources, one or more supplementary sources, and/or the like. In some example implementations, an auxiliary source and/or a supplementary source associated with a user may be associated with a standard source associated with the user. For example, an entity, such as a financial entity managing the standard source and the auxiliary source, may increase a balance of auxiliary resources in the auxiliary source based on the user performing one or more actions using standard resources in the standard source (e.g., conducting a transaction and/or distribution using the standard source, maintaining a particular balance in the standard source, receiving information regarding the standard source in a particular format, and/or the like).

As used herein, a “distribution,” such as a resource distribution, a standard resource distribution, an auxiliary resource distribution, and/or the like, may refer to any transaction, activities, or communication between one or more entities, between the user and the one or more entities, and/or the like. A resource distribution may refer to any distribution of resources such as, but not limited to, a payment, processing of funds, purchase of goods or services, a return of goods or services, a payment transaction, a credit transaction, other interactions involving a user's resource or account, and/or the like. In the context of an entity such as a financial institution, a resource distribution may refer to one or more of: a sale of goods and/or services, initiating an automated teller machine (ATM) or online financial session, an account balance inquiry, a rewards transfer, an account money transfer or withdrawal, opening a financial application on a user's computer or mobile device, a user accessing their e-wallet, any other interaction involving the user and/or the user's device that invokes and/or is detectable by the financial institution, and/or the like. In some embodiments, the user may authorize a resource distribution using a payment instrument (credit cards, debit cards, checks, digital wallets, currency, loyalty points) and/or payment credentials (account numbers, payment instrument identifiers). A resource distribution may include one or more of the following: renting, selling, and/or leasing goods and/or services (e.g., groceries, stamps, tickets, DVDs, vending machine items, and/or the like); making payments to creditors (e.g., paying monthly bills; paying federal, state, and/or local taxes, and/or the like); sending remittances; loading money onto stored value cards (SVCs) and/or prepaid cards; donating to charities; and/or the like. Unless specifically limited by the context, a “resource distribution,” a “resource transfer,” a “transaction”, a “transaction event,” and/or a “point of transaction event” may refer to any activity between a user, a merchant, an entity, and/or the like. In some embodiments, a resource distribution and/or transaction may refer to financial transactions involving direct or indirect movement of funds through traditional paper transaction processing systems (e.g., paper check processing) or through electronic transaction processing systems. In this regard, resource distributions and/or transactions may refer to the user initiating a purchase for a product, service, or the like from a merchant. Typical financial distributions and/or financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, and/or the like. When describing that resource transfers or transactions are evaluated, such descriptions may mean that the transaction has already occurred, is in the process of occurring or being processed, or has yet to be processed/posted by one or more financial institutions. In some embodiments, a resource distribution and/or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and/or the like.

As used herein, “payment instrument” may refer to an electronic payment vehicle, such as an electronic credit, debit card, and/or the like. In some embodiments, the payment instrument may not be a “card” and may instead be account identifying information stored electronically in a user device, such as payment credentials and/or tokens and/or aliases associated with a digital wallet, account identifiers stored by a mobile application, and/or the like. In some embodiments, the term “module” with respect to an apparatus may refer to a hardware component of the apparatus, a software component of the apparatus, and/or a component of the apparatus that comprises both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, “authentication credentials” may be any information that may be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like.

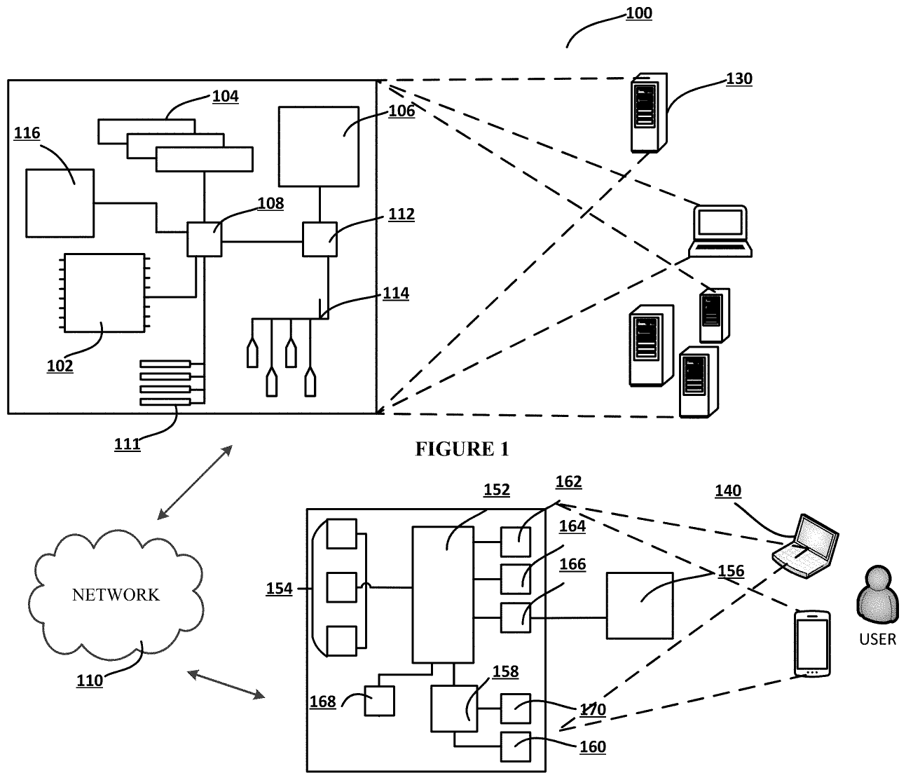

FIG. 1 presents an exemplary block diagram of a system environment 100 for adjusting resource allocation based on user selection within a technical environment, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to execute resource transfers and/or resource distributions using one or more applications stored thereon. The one or more applications may be configured to communicate with the system 130, execute a transaction, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes for adjusting resource allocations based on user selection, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, and/or the like. The system 130 may be located at a facility associated with the entity and/or remotely from the facility associated with the entity.

The memory 104 may store information within the system 130. In one implementation, the memory 104 may be a volatile memory unit or units, such as volatile random access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application, and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry, and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140, and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, GPS (Global Positioning System) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user can provide input to the computer, and/or a pointing device (e.g., a mouse or a trackball) by which the user can provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

As noted above, an entity may provide one or more resource allocation offers to a user to encourage the user to conduct resource distributions with one or more other entities. For example, the other entities may provide, to the entity, lists of resource allocation offers for the entity to provide to the user in an effort to encourage the user to conduct resource distributions with the other entities. However, monitoring and/or updating resource allocation offers consumes computing resources (e.g., processing resources, memory resources, power resources, communication resources, and/or the like) and/or network resources. Accordingly, when resource allocation offers are not utilized by users, the computing resources and/or network resources consumed monitoring and/or updating resource allocation offers are wasted.

Some embodiments described herein provide a system, a computer program product, and/or a method for adjusting resource allocation based on user selection. For example, a system may be configured to provide one or more resource allocation offers to a user device associated with a user and receive, from the user device, an acceptance of a resource allocation offer. The system may be further configured to, adjust, based on the acceptance of the first resource allocation offer, another resource allocation offer from an initial amount of resources to an adjusted amount of resources that is greater than the initial amount of resources and provide the second resource allocation offer to the user device. By increasing the amount of resources of the second resource allocation offer, the system may increase a likelihood that the user will accept the second resource allocation offer, which decreases a likelihood that computing resources and/or network resources consumed monitoring and/or updating resource allocation offers are wasted. In this way, embodiments of the present invention may conserve computing resources and/or network resources.

Furthermore, in some embodiments, a system may generate resource allocation offers based on historical data associated with resource distributions. For example, the system may generate resource allocation offers, which, based on the historical data, have an increased likelihood of being accepted by a user. By increasing a likelihood that the user will accept a resource allocation offer, the system may decrease a likelihood that computing resources and/or network resources consumed monitoring and/or updating resource allocation offers are wasted.

Additionally, or alternatively, a system may adjust a second resource allocation offer based on rules and/or using machine learning. For example, the system may be configured by rules and/or may use machine learning to adjust a second resource allocation offer based on the acceptance of a first resource allocation offer, such that the second resource allocation offer may be provided to the user device in real time and/or near-real time. By providing the second resource allocation offer in real time and/or near-real time, the system may increase a likelihood that the user will accept the second resource allocation offer, which decreases a likelihood that computing resources and/or network resources consumed monitoring and/or updating resource allocation offers are wasted. Furthermore, by adjusting the second resource allocation offer based on rules and/or using machine learning, the system may conserve computing resources and/or network resources that would otherwise be consumed by transmitting information to each of the entities regarding the acceptance of the first resource allocation offer, receiving information from each of the entities, updating a list of resource allocation offers, and/or the like.

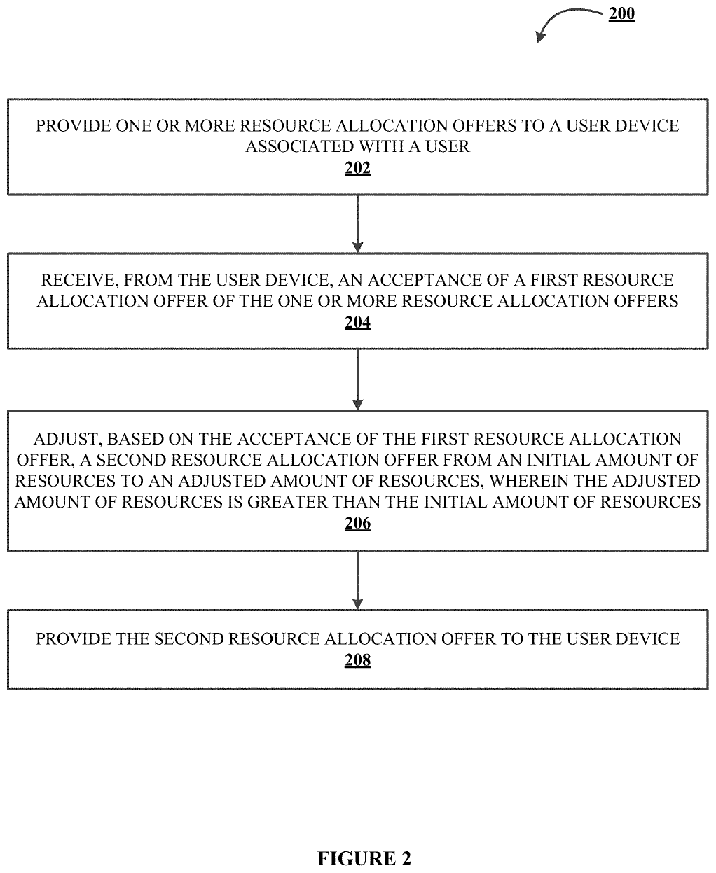

FIG. 2 illustrates a process flow 200 for adjusting resource allocation based on user selection within a technical environment, in accordance with an embodiment of the invention. As shown in block 202, the process flow may include providing one or more resource allocation offers to a user device associated with a user. In some embodiments, the process flow may include providing a plurality of resource allocation offers to a user device. For example, a plurality of entities may provide, to a system (e.g., similar to one or more of the systems described herein with respect to FIG. 1), lists of resource allocation offers for the system to provide to the user in an effort to encourage the user to conduct resource distributions with the entities. The system may provide process the lists of resource allocation offers and provide, to the user device, the resource allocation offers.

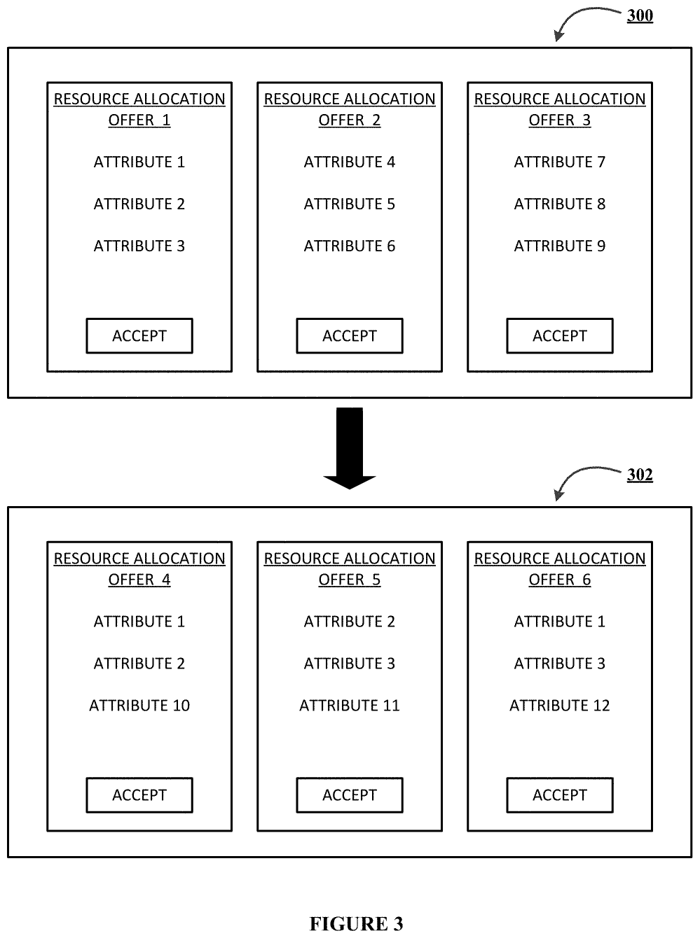

In some embodiments, the process flow may include causing the user device to display the one or more resource allocation offers. For example, the system may provide a graphical user interface including the one or more resource allocation offers for display by the user device. In some embodiments, the graphical user interface may be similar to the graphical user interface shown in and described herein with respect to FIG. 3.

Additionally, or alternatively, the process flow may include providing a notification including the one or more resource allocation offers to the user device. For example, the notification may include a message, an application notification, an alert, an email, physical mail, and/or the like.

In some embodiments, the process flow may include generating, based on historical data associated with resource distributions, the one or more resource allocation offers. For example, the system may, using machine learning, determine based on the historical data associated with resource distributions, which resource allocation offers have a likelihood of being accepted by the user that satisfies a threshold. In some embodiments, the historical data associated with resource distributions may include information and/or data associated with previously accepted resource allocation offers, previously provided but not accepted resource allocation offers, amounts of resource distributions, entities associated with resource distributions, types of entities associated with resource distributions, sources associated with resource distributions, and/or the like. In some embodiments, the historical data associated with resource distributions may include historical data associated with resource distributions associated with the user (e.g., specific to the user), historical data associated with resource distributions associated with multiple users (e.g., multiples customers of an entity, multiple users within a geographic region, multiple users having one or more common attributes, and/or the like), and/or the like.

As shown in block 204, the process flow may include receiving, from the user device, an acceptance of a first resource allocation offer of the one or more resource allocation offers. In some embodiments, the user may provide user input (e.g., via a graphical user interface, via an input device, and/or the like) to accept a first resource allocation offer, and the user device, based on the user input, may transmit, to the system, an acceptance of the first resource allocation offer. The system may receive the acceptance of the first resource allocation offer.

As shown in block 206, the process flow may include adjusting, based on the acceptance of the first resource allocation offer, a second resource allocation offer from an initial amount of resources to an adjusted amount of resources, wherein the adjusted amount of resources is greater than the initial amount of resources. For example, the system may adjust, based on the acceptance of the first resource allocation offer, a second resource allocation offer from an initial amount of resources to an adjusted amount of resources. In some embodiments, the process flow may include adjusting, based on the acceptance of the first resource allocation offer, one or more attributes and/or terms of the second resource allocation offer, such as an amount of resources associated with the second resource allocation offer, a time and/or period of time associated with the second resource allocation offer, a condition associated with the second resource allocation offer, and/or the like.

In some embodiments, the second resource allocation offer is related to the first resource allocation offer. For example, the entity that provided the first resource allocation offer may also have provided the second resource allocation offer, and, to encourage the user to initiate resource distributions with the entity and/or to accept additional resource allocation offers, the system may (e.g., based on instructions from the entity) increase an amount of resources associated with the second resource allocation offer. As another example, the first resource allocation offer may be for a first type of resources, and the second resource allocation offer may be for a second type of resources, where the second type of resources includes resources typically used in conjunction with resources of the first type. In some embodiments, the second resource allocation offer and the first resource allocation offer may have similar attributes.

In some embodiments, the process flow may include adjusting the second resource allocation offer based on rules. For example, the system may receive rules for adjusting resource allocation offers from entities providing the resource allocation offers, and may adjust, based on the acceptance of one resource allocation offer, one or more other resource allocation offers according to the rules.

In some embodiments, the process flow may include adjusting the second resource allocation offer using machine learning. For example, the system may use machine learning and/or a forecasting model to predict, based on the acceptance of the first resource allocation offer and/or based on historical data associated with resource distributions, which other resource allocation offers the user is likely to accept, and may adjust amounts of resource of the other resource allocation offers the user is likely to accept (e.g., to encourage the user to accept the other resource allocation offers).

In some embodiments, the process flow may include communicating with an entity associated with the second resource allocation offer to adjust the second resource allocation offer. For example, the system may, based on the acceptance of the first resource allocation offer, transmit information associated with the acceptance of the first resource allocation offer to one or more entities, may receive, from the one or more entities, updated amounts of resources for other resource allocation offers, and may adjust the other resource allocation offers based on the updated amounts of resources. In some embodiments, the process flow may include communicating with entities associated with resource allocation offers in real time or near-real time such that the entities may provide instructions to adjust the resource allocation offers as a user accepts resource allocation offers.

As shown in block 208, the process flow may include providing the second resource allocation offer to the user device. In some embodiments, the process flow may include providing a plurality of resource allocation offers, including the second resource allocation offer, to the user device. In some embodiments, the process flow may include providing the second resource allocation offer to the user device in a manner similar to any of those described herein with respect to block 202 and/or providing the one or more resource allocation offers to the user device.

In some embodiments, the process flow may include, when providing the second resource allocation offer to the user device, causing the user device to display a graphical user interface including the second resource allocation offer. In some embodiments, the graphical user interface may be similar to the graphical user interface shown in and described herein with respect to FIG. 3.

In some embodiments, the process flow may include, when adjusting the second resource allocation offer, communicating with a plurality of entities associated with a plurality of resource allocation offers, wherein the plurality of resource allocation offers includes the second resource allocation offer. Additionally, or alternatively, the process flow may include, when adjusting the second resource allocation offer, receiving from the plurality of entities, updated amounts of resources for the plurality of resource allocation offers, wherein the updated amounts of resources are updated based on the acceptance of the first resource allocation offer. In some embodiments, the process flow may include, when providing the second resource allocation offer to the user device, provide the plurality of resource allocation offers to the user device.

In some embodiments, the process flow may include receiving, from the user device, another acceptance of the second resource allocation offer, adjusting, based on the other acceptance of the second resource allocation offer, a third resource allocation offer from a first amount of resources to a second amount of resources, wherein the first amount of resources is greater than the second amount resources, and providing the third resource allocation offer to the user device. For example, the user device may provide the second resource allocation offer to the user and the user may accept the second resource allocation offer in a manner similar to any of those described herein with respect to the one or more resource allocation offers and the acceptance of the first resource allocation offer. Additionally, or alternatively, the system may receive the acceptance of the second resource allocation offer in a manner similar to any of those described herein with respect to receiving the acceptance of the first resource allocation offer. In some embodiments, the system may adjust the third resource allocation offer in a manner similar to any of those described herein with respect to adjusting the second resource allocation offer. Additionally, or alternatively, the system may provide the third resource allocation offer to the user device in a manner similar to any of those described herein with respect to the one or more resource allocation offers.

In some embodiments, the process flow may include adjusting one or more resource allocation offers based on each acceptance of a resource allocation offer. For example, the system may provide a plurality of resource allocation offers, and, each time a user accepts one of the resource allocation offers, the system may adjust the plurality of resource allocation offers. In some embodiments, the system may increase an amount of resources associated with each of the plurality of resource allocation offers each time a user accepts one of the resource allocation offers. In this way, the system may provide increasingly better resource allocation offers to the user each time the user accepts a resource allocation offer.

In some embodiments, the process flow may include causing an autonomous vehicle (e.g., a driverless car and/or truck, an unmanned aerial vehicle, a computer-controlled robot, and/or the like) to perform an action. For example, the process flow may include causing, based on an acceptance of a resource allocation offer (e.g., the first resource allocation offer, the second resource allocation offer, the third resource allocation offer, and/or the like), an autonomous vehicle to go to a location and/or an address (e.g., to pick up the user and drive the user to another location and/or another address). As another example, the process flow may include causing, based on an acceptance of a resource allocation offer, an autonomous vehicle to deliver an object to an address. As another example, the process flow may include, causing, based on acceptance of a resource allocation offer, an autonomous vehicle to go to a location and/or an address to receive an object and/or deliver the object to another location and/or another address.

In some embodiments, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system. Further, any suitable model (e.g., machine learning, non-machine learning, etc.) can be used in generating data relevant to the system. In some embodiments, the one or more machine learning algorithms may be predictive modeling algorithms configured to use data and statistics to predict outcomes with forecasting models.

In some embodiments, the forecasting model may be generated by training on data regarding the user (e.g., resource allocation offers accepted by the user and/or other users, resource distributions associated with the user and/or other users, and/or the like) over a predetermined past period of time. In doing so, the system may be configured to determine, for each of the resource allocation offers, a likelihood of the user accepting the resource allocation offer, and whether the likelihood satisfies a threshold. In some embodiments, the one or more machine learning algorithms may be used to calculate the likelihood of the user accepting the resource allocation offer, and whether the likelihood satisfies a threshold.

FIG. 3 illustrates a graphical user interface for adjusting resource allocation based on user selection, in accordance with an embodiment of the invention. As shown in FIG. 3, the graphical user interface may include an first graphical user interface 300 and a second graphical user interface 302.

As also shown in FIG. 3, the first graphical user interface 300 may include resource allocation offer 1, resource allocation offer 2, and resource allocation offer 3 as well as buttons to receive user input accepting one of the resource allocation offers. The first graphical user interface 300 may also include attributes of each of the resource allocation offers. For example, and as show in FIG. 3, each of the resource allocation offers may have different attributes.

In some embodiments, user input accepting one of the resource allocation offers may trigger display of the second graphical user interface 302. For example, and as shown in FIG. 3, user input accepting resource allocation offer 1 may trigger display of the second graphical user interface 302 including resource allocation offer 4, resource allocation offer 5, and resource allocation 6.

In some embodiments, the resource allocation offers of the second graphical user interface 302 may be related to the resource allocation offer accepted by the user input. For example, and as shown in FIG. 3, resource allocation offer 4, resource allocation 5, and resource allocation offer 6 may have similar attributes to resource allocation offer 1, which was accepted by the user input. In this regard, resource allocation offer 1 and resource allocation offer 4 may both have attribute 1 and attribute 2. Resource allocation offer 1 and resource allocation offer 5 may both have attribute 2 and attribute 3. Resource allocation offer 1 and resource allocation offer 6 may both have attribute 1 and attribute 3. In this way, the graphical user interface may adjust resource allocation based on user selection.

Merchants and/or service providers may partner with a financial institution to provide offers, such as discounts, increased reward points, additional value, and/or the like, to customers for utilizing cash and/or credit associated with the financial institution to complete transactions with the merchants and/or service providers. The financial institution may receive the terms of the offers from the merchants and/or service providers, and may provide the offers to customers (e.g., via an application on a user device, via a website, and/or the like). In some embodiments, the financial institution may provide an offer to customers to approve one or more types of service (e.g., paperless billing, autopay, and/or the like). Customers may accept the offers through the financial institution and receive a benefit according to the terms of the offer. However, monitoring and/or updating the offers consumes computing resources (e.g., processing resources, memory resources, power resources, communication resources, and/or the like) and/or network resources. Accordingly, when the offers are not utilized by users, the computing resources and/or network resources consumed monitoring and/or updating the offers are wasted. The financial institution, the merchants, and/or the service providers may partner to provide the offers to improve the satisfaction of the user with the financial institution, the merchants, and/or the service providers, encourage the user to complete additional transactions with the financial institution, the merchants, and/or the service providers, and/or the like. However, when the user does not utilize the offers, providing the offers does not improve the satisfaction of the user with the financial institution, the merchants, and/or the service providers, encourage the user to complete additional transactions with the financial institution, the merchants, and/or the service providers, and/or the like. Some embodiments described herein provide a system, a computer program product, and/or a method for adjusting offers based on customer acceptances of other offers. For example, the system, the computer program product, and/or the method may create a first offer, then once accepted by the customer, trigger another, potentially related, offer. As the customer accepts each additional offer, the system, the computer program product, and/or the method increases the overall values of the offers. The system, the computer program product, and/or the method may use rules and/or real time communications with merchant systems to adjust the offer listings and provide pricing in real time as the customer selects various offers. By adjusting the offers based on customer acceptances, the customer is more likely to accept additional offers, and the system, the computer program product, and/or the method conserves the computing resources and/or network resources used for monitoring and/or updating the offers that would otherwise be wasted.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for adjusting resource allocation based on user selection, the system comprising:
at least one non-transitory storage device; and
at least one processing device coupled to the at least one non-transitory storage device, wherein the at least one processing device is configured to:
provide one or more resource allocation offers to a user device associated with a user;
receive, from the user device, an acceptance of a first resource allocation offer of the one or more resource allocation offers;
adjust, based on the acceptance of the first resource allocation offer, a second resource allocation offer from an initial amount of resources to an adjusted amount of resources, wherein the adjusted amount of resources is greater than the initial amount of resources; and
provide the second resource allocation offer to the user device.

2. The system of claim 1, wherein the at least one processing device is configured to, when providing the one or more resource allocation offers to the user device, cause the user device to display the one or more resource allocation offers via a graphical user interface.

3. The system of claim 1, wherein the at least one processing device is configured to, when providing the one or more resource allocation offers to the user device, provide a notification comprising the one or more resource allocation offers to the user device.

4. The system of claim 1, wherein the at least one processing device is configured to generate, based on historical data associated with resource distributions, the one or more resource allocation offers.

5. The system of claim 4, wherein the historical data associated with resource distributions comprises historical data associated with resource distributions associated with the user.

6. The system of claim 4, wherein the historical data associated with resource distributions comprises historical data associated with resource distributions associated with multiple users.

7. The system of claim 1, wherein the second resource allocation offer is related to the first resource allocation offer.

8. The system of claim 1, wherein the at least one processing device is configured to adjust the second resource allocation offer based on rules.

9. The system of claim 1, wherein the at least one processing device is configured to, when adjusting the second resource allocation offer, communicate with an entity associated with the second resource allocation offer.

10. The system of claim 1, wherein the at least one processing device is configured to, when adjusting the second resource allocation offer, communicate with a plurality of entities associated with a plurality of resource allocation offers, wherein the plurality of resource allocation offers includes the second resource allocation offer.

11. The system of claim 1, wherein the at least one processing device is configured to:
when adjusting the second resource allocation offer, communicate with a plurality of entities associated with a plurality of resource allocation offers, wherein the plurality of resource allocation offers includes the second resource allocation offer;
when adjusting the second resource allocation offer, receive from the plurality of entities, updated amounts of resources for the plurality of resource allocation offers, wherein the updated amounts of resources are updated based on the acceptance of the first resource allocation offer; and
when providing the second resource allocation offer to the user device, provide the plurality of resource allocation offers to the user device.

12. The system of claim 1, wherein the at least one processing device is configured to:
when providing the one or more resource allocation offers to the user device, provide a plurality of resource allocation offers to the user device;
when adjusting the second resource allocation offer, communicate with a plurality of entities associated with the plurality of resource allocation offers, wherein the plurality of resource allocation offers includes the second resource allocation offer;
when adjusting the second resource allocation offer, receive from the plurality of entities, updated amounts of resources for the plurality of resource allocation offers, wherein the updated amounts of resources are updated based on the acceptance of the first resource allocation offer; and
when providing the second resource allocation offer to the user device, provide the plurality of resource allocation offers to the user device.

13. The system of claim 1, wherein the at least one processing device is configured to:
receive, from the user device, another acceptance of the second resource allocation offer;
adjust, based on the other acceptance of the second resource allocation offer, a third resource allocation offer from a first amount of resources to a second amount of resources, wherein the first amount of resources is greater than the second amount resources; and
provide the third resource allocation offer to the user device.

14. The system of claim 1, wherein the at least one processing device is configured to cause, based on the acceptance of the first resource allocation offer, an autonomous vehicle to deliver an object to an address.

15. The system of claim 1, wherein the at least one processing device is configured to:
receive, from the user device, another acceptance of the second resource allocation offer; and
cause, based on the other acceptance of the second resource allocation offer, an autonomous vehicle to deliver an object to an address.

16. A computer program product for adjusting resource allocation based on user selection, the computer program product comprising a non-transitory computer-readable medium comprising code causing a first apparatus to:
provide one or more resource allocation offers to a user device associated with a user;
receive, from the user device, an acceptance of a first resource allocation offer of the one or more resource allocation offers;
adjust, based on the acceptance of the first resource allocation offer, a second resource allocation offer from an initial amount of resources to an adjusted amount of resources, wherein the adjusted amount of resources is greater than the initial amount of resources; and
provide the second resource allocation offer to the user device.

17. The computer program product of claim 16, wherein the non-transitory computer-readable medium comprises code causing the first apparatus to, when providing the one or more resource allocation offers to the user device, cause the user device to display the one or more resource allocation offers via a graphical user interface.

18. The computer program product of claim 16, wherein the non-transitory computer-readable medium comprises code causing the first apparatus to, when providing the one or more resource allocation offers to the user device, provide a notification comprising the one or more resource allocation offers to the user device.

19. The computer program product of claim 16, wherein the non-transitory computer-readable medium comprises code causing the first apparatus to generate, based on historical data associated with resource distributions, the one or more resource allocation offers.

20. A method for adjusting resource allocation based on user selection, the method comprising:
providing one or more resource allocation offers to a user device associated with a user;
receiving, from the user device, an acceptance of a first resource allocation offer of the one or more resource allocation offers;
adjusting, based on the acceptance of the first resource allocation offer, a second resource allocation offer from an initial amount of resources to an adjusted amount of resources, wherein the adjusted amount of resources is greater than the initial amount of resources; and
providing the second resource allocation offer to the user device.
